(19) United States
(12) Patent Application Publication
(10) Pub. No.: US 2026/0030945 A1
(43) Pub. Date: Jan. 29, 2026

(54) MONEY DEPOSITING AND DISPENSING APPARATUS AND METHOD

(71) Applicant: TOSHIBA TEC KABUSHIKI KAISHA, Tokyo (JP)

(72) Inventor: Yuki Taniike, Mishima Shizuoka (JP)

(21) Appl. No.: 19/176,201

(22) Filed: Apr. 11, 2025

(30) Foreign Application Priority Data
Jul. 25, 2024 (JP) 2024-119493

(51) Int. Cl. G07D 11/14; G07D 11/26

(52) U.S. Cl. CPC G07D 11/14; G07D 11/26; G07D 2201/00; G07D 2211/00

(57) ABSTRACT

A self-service POS terminal (a money depositing and dispensing apparatus) is capable of performing at least cash settlement and includes a denomination identification unit (an identification unit) configured to identify a denomination of money deposited to a coin depositing port (a depositing port) or a bill depositing port (a depositing port), a deposited money information storage unit (a storage unit) configured to store denominations, numbers, and depositing order of pieces of money deposited during one checkout, an operator determination unit configured to determine whether the self-service POS terminal is being operated by a customer or being operated by a store clerk, and a money return unit configured to, on condition that it is determined that the self-service POS terminal is being operated by the customer, if pieces of money exceeding a predetermined value in number were deposited, return the money deposited in excess of the predetermined number.

### CROSS-REFERENCE TO RELATED APPLICATION

This application is based upon and claims the benefit of priority from Japanese Patent Application No. 2024-119493, filed on July 25, 2024, the entire contents of which are incorporated herein by reference.

### FIELD

Embodiments described herein relate generally to a money depositing and dispensing apparatus and a method.

### BACKGROUND

There is proposed a self-service POS terminal with which a customer pays, with coins or bills, a price of a commodity that the customer purchases.

In the self-service POS terminal of the related art explained above, since the number of pieces of money that can be deposited to a change machine is not limited, a large amount of coins are likely to be deposited. If a large amount of coins are deposited in this way, since a time required for checkout increases, a shopper is likely to wait for a cash register for a longer time. Since the quantity of money deposited to the change machine increases, it is more likely that an operation failure such as clogging of the money is caused. Further, since the quantity of money deposited to the change machine increases, it is likely that labor and time for collecting the money increase.

### DESCRIPTION OF THE DRAWINGS

FIG. 1 is an exterior view illustrating an example of a self-service POS terminal including a money depositing and dispensing apparatus in an embodiment;

FIG. 2 is an exterior view illustrating an example of a state in which a front cover of the self-service POS terminal is opened;

FIG. 3 is an exterior view illustrating an example of a coin automatic change machine;

FIG. 4 is an exterior view illustrating an example of a bill automatic change machine;

FIG. 5 is a hardware block diagram illustrating an example of a hardware configuration of the self-service POS terminal;

FIG. 6 is a diagram illustrating an example of a data structure of a deposited money record file;

FIG. 7 is a functional block diagram illustrating an example of a functional configuration of the self-service POS terminal; and

FIG. 8 is a flowchart illustrating an example of a flow of processing performed by the self-service POS terminal.

### DETAILED DESCRIPTION

Embodiments provide a money depositing and dispensing apparatus and a method capable of, if being operated by a customer, limiting the number of pieces of money that can be deposited.

In general, according to one embodiment, a money depositing and dispensing apparatus is capable of performing at least cash settlement and includes an identification unit, a storage unit, an operator determination unit, and a money return unit. The identification unit identifies a denomination of money deposited to a depositing port included in the money depositing and dispensing apparatus. The storage unit stores denominations, numbers, and depositing order of pieces of money deposited during one checkout. The operator determination unit determines whether the money depositing and dispensing apparatus is being operated by a customer or being operated by a store clerk. On condition that it is determined that the money depositing and dispensing apparatus is being operated by the customer, if pieces of money exceeding a predetermined value in number were deposited, the money return unit returns the money deposited in excess of the predetermined value.

### (Embodiment)

A self-service POS terminal 10 in an embodiment of the present disclosure is explained.

### (Explanation of a schematic configuration of the self-service POS terminal)

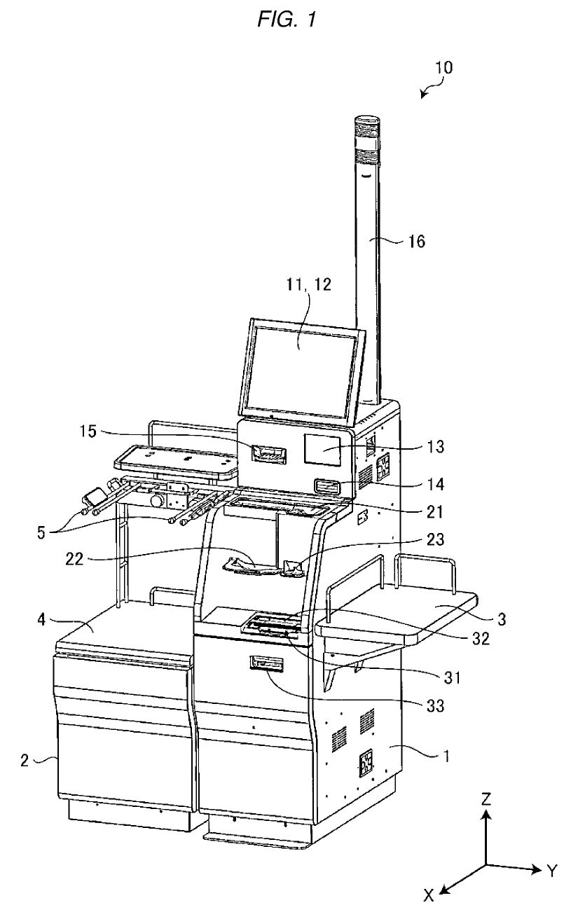

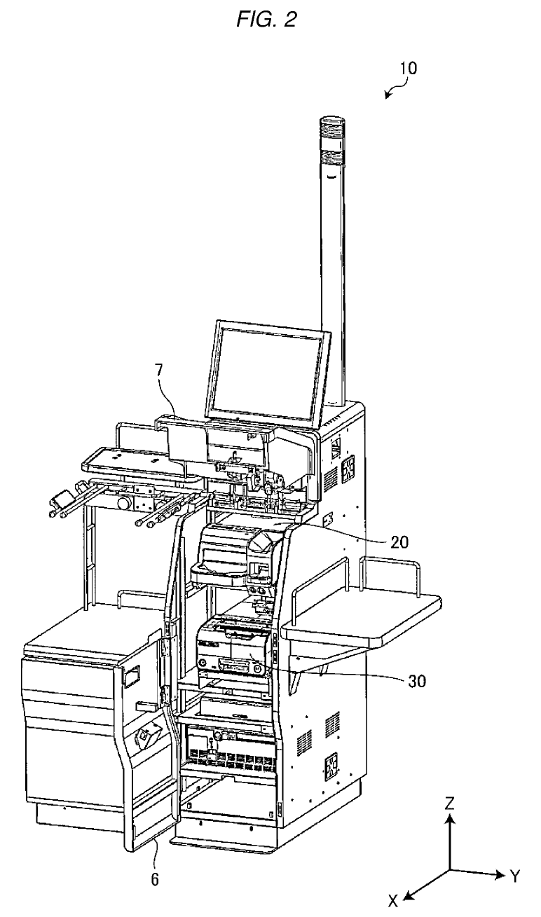

A schematic configuration of the self-service POS terminal 10 is explained with reference to FIGS. 1 and 2. FIG. 1 is an exterior view illustrating an example of a self-service POS terminal including a money depositing and dispensing apparatus in the embodiment. FIG. 2 is an exterior view illustrating an example of a state in which a front cover of the self-service POS terminal is opened.

The self-service POS terminal 10 is a checkout machine that, in a store such as a retail store, a customer operates by himself or herself to thereby perform registration and payment for a commodity that the customer desires to purchase. The self-service POS terminal 10 is an example of the money depositing and dispensing apparatus in the present disclosure.

The self-service POS terminal 10 includes, in an upper part of a housing 1, various devices for performing commodity registration and settlement relating to the registered commodity.

On a side surface of the housing 1, a commodity placing table 3 is provided on a Y-axis positive side. The customer places a shopping basket or the like storing unregistered commodities on the commodity placing table 3.

A housing 2 is installed on a side opposite to the commodity placing table 3, that is, a Y-axis negative side of the housing 1. A commodity placing table 4 is formed on the upper surface of the housing 2. The customer stores the unregistered commodities in a reusable shopping bag, a register bag, or the like placed on the commodity placing table 4. A hook 5 for hooking the reusable shopping bag or the register bag is installed above the commodity placing table 4.

A display device 11, an operation device 12, a scanner 13, a card reader 14, a receipt printer 15, and a warning lamp 16 are provided in an upper part of the housing 1.

The display device 11 displays, to the customer, various kinds of information relating to commodity registration and settlement. The various kinds of information relating to the commodity registration is, for example, registered commodity information and a purchase total amount. The various kinds of information relating to the settlement is, for example, a purchase amount. The display device 11 is configured by, for example, a liquid crystal monitor or an organic EL monitor.

The operation device 12 acquires, from the customer, various kinds of operation information relating to commodity registration and settlement. The various kinds of operation information relating to commodity registration and settlement is, for example, an instruction to start commodity registration and an instruction to complete registration. The operation device 12 is, for example, a touch panel disposed in a state of being stacked on the display device 11.

The scanner 13 includes a not-illustrated camera on the inside and images a code symbol (for example, a barcode or a two-dimensional code), in which a commodity code is registered, held over a reading window on the front surface. The self-service POS terminal 10 recognizes the commodity code registered in the code symbol reflected in a captured image to thereby register a commodity corresponding to the commodity code.

The card reader 14 reads and writes a member code, a cumulative point, and the like of the customer recorded in a card medium such as a point card carried by the customer and inserted from an insertion port.

The receipt printer 15 dispenses, from a dispensing port, a receipt on which a result of a transaction is printed.

The warning lamp 16 is installed at the distal end of a pole extending upward from the housing 1 and emits light in blue, red, or the like. The warning lamp 16 emits light in a color and a lighting pattern corresponding to an operation state of the self-service POS terminal 10. For example, if the customer does not know how to operate the self-service POS terminal 10, the customer presses a store clerk call button displayed on the display device 11. Then, the warning lamp 16 is lit to ask for help from a store clerk around the customer.

A coin depositing port 21 to which the customer deposits coins if paying a price of a commodity and a bill depositing port 31 to which the customer deposits bills if paying a price of a commodity are provided in an upper part of the housing 1. The coin depositing port 21 and the bill depositing port 31 are examples of the depositing port in the present disclosure.

A coin return port 22 from which coins serving as change are discharged, a bill return port 32 from which bills serving as change are returned, a foreign matter discharge port 23 from which foreign matters deposited to the coin depositing port 21 are discharged, and a foreign matter discharge port 33 from which foreign matters deposited to the bill depositing port 31 are discharged are provided in an upper part of the housing 1.

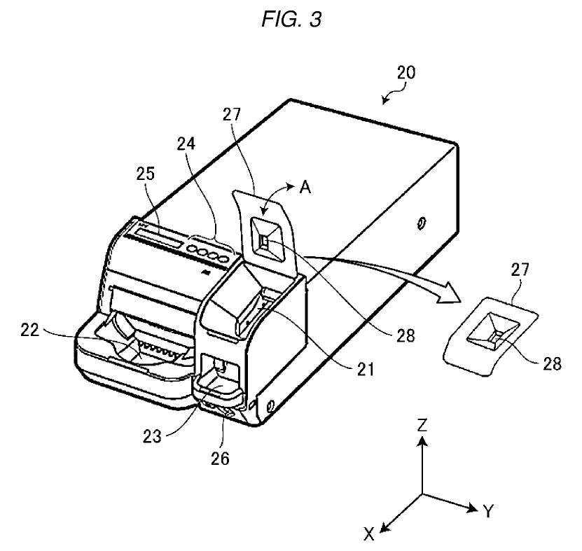

The coin depositing port 21, the coin return port 22, and the foreign matter discharge port 23 are provided in a coin automatic change machine 20 (see FIG. 2) included in the housing 1. The coin automatic change machine 20 is explained in detail below (see FIG. 3).

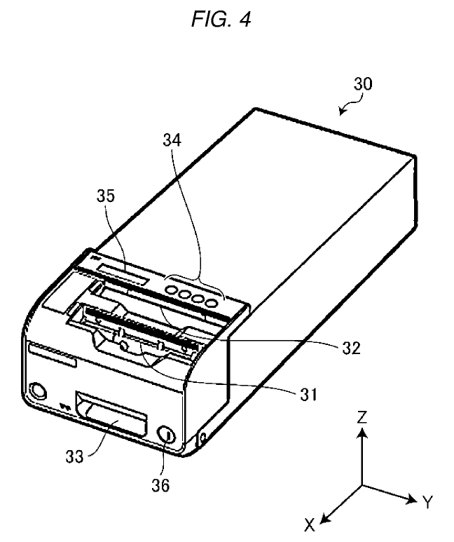

The bill depositing port 31, the bill return port 32, and the foreign matter discharge port 33 are provided in a bill automatic change machine 30 (see FIG. 2) included in the housing 1. The bill automatic change machine 30 is explained in detail below (see FIG. 4).

The self-service POS terminal 10 in the present embodiment is explained as an apparatus that performs only cash settlement. However, the self-service POS terminal 10 may include a not-illustrated settlement terminal and perform cashless settlement (credit settlement, code settlement, electronic money settlement, and the like) by a settlement terminal in addition to the cash settlement.

A front cover 6 and a front cover 7 capable of opening and closing illustrated in FIG. 2 are provided on the front surface (an X-axis positive side) of the housing 1 of the self-service POS terminal 10.

The front cover 6 turns around a turning axis extending along a Z axis to thereby expose the bill automatic change machine 30 included in the housing 1. The front cover 7 turns around a turning axis extending along a Y axis to thereby expose the coin automatic change machine 20 included in the housing 1. The front covers 6 and 7 are an example of the cover in the present disclosure.

A maintenance administrator of a store opens the front covers 6 and 7 and performs maintenance of the coin automatic change machine 20 and the bill automatic change machine 30. The maintenance of the coin automatic change machine 20 and the bill automatic change machine 30 is, for example, supply of change coins and change bills, collection of coins stored in the coin automatic change machine 20 and bills stored in the bill automatic change machine 30, and maintenance and management of the coin automatic change machine 20 and the bill automatic change machine 30.

### (Schematic configuration of the coin automatic change machine)

A schematic configuration of the coin automatic change machine 20 is explained with reference to FIG. 3. FIG. 3 is an exterior view illustrating an example of the coin automatic change machine.

The coin automatic change machine 20 determines whether coins deposited by the customer for payment for a commodity are regular coins. The coin automatic change machine 20 integrates a deposit amount of the regular coins and returns coins of an amount exceeding a payment amount as change. The coin automatic change machine 20 operates in cooperation with the bill automatic change machine 30 explained below and sets, as the deposit amount, a total amount of coins deposited to the coin automatic change machine 20 and bills deposited to the bill automatic change machine 30. If non-regular coins are deposited, the coin automatic change machine 20 performs reject processing for returning the coins.

In order to perform these operations, the coin automatic change machine 20 includes a coin identification function of identifying regular coins, a storing function of conveying deposited coins and storing the coins in different storing units for each of denominations, a change return function of returning a difference value between a deposit amount and a payment amount as coins serving as change, and a reject function of returning non-regular coins. Since all of these functions are well known, detailed explanation of the functions is omitted.

Further, if the customer deposits coins and a total number of the deposited coins exceeds a predetermined value, the coin automatic change machine 20 in the present embodiment returns the deposited coins exceeding the predetermined value. For example, if the store clerk supplies coins serving as change, collects deposited coins, and performs maintenance of the coin automatic change machine 20, even if coins exceeding the predetermined value in number were deposited, the coin automatic change machine 20 does not return the coins.

As illustrated in FIG. 3, the coin automatic change machine 20 includes the coin depositing port 21, the coin return port 22, the foreign matter discharge port 23, operation buttons 24, an information monitor 25, and a key operation section 26 in the front and on the upper surface on the front side in a substantially rectangular parallelepiped housing. If the front cover 7 (see FIG. 2) is closed, the coin depositing port 21, the coin return port 22, and the foreign matter discharge port 23 are exposed to the surface of the self-service POS terminal 10 from a not-illustrated opening provided in the front cover 7. On the other hand, if the front cover 7 is closed, the operation buttons 24, the information monitor 25, and the key operation section 26 are hidden on the inside of the housing 1.

In the coin depositing port 21, a depositing port cover 27 that openably and closably turns in a direction of an arrow A illustrated in FIG. 3 around a turning axis extending along the Y axis is provided. The depositing port cover 27 includes a hole section 28 through which one coin can pass. If the depositing port cover 27 is closed, the coin automatic change machine 20 limits coins to be deposited to the coin depositing port 21 one by one through the hole section 28 and limits the number of coins deposited at a time. On the other hand, if the depositing port cover 27 is opened, the coin automatic change machine 20 enables a plurality of coins to be deposited to the coin depositing port 21 at a time. If the customer uses the self-service POS terminal 10, the depositing port cover 27 is closed to limit coins to be deposited to the coin depositing port 21 one by one. On the other hand, if the store clerk uses the self-service POS terminal 10, for example, if supplying change, the store clerk opens the depositing port cover 27 to enable a plurality of coins to be deposited to the coin depositing port 21 at a time. Accordingly, it is possible to reduce a time required for the supply of coins. After finishing the work, the store clerk returns the depositing port cover 27 to the closed state.

The operation buttons 24 are various buttons to be operated by the store clerk and give various instructions to the coin automatic change machine 20. For example, if a maintenance button among the operation buttons 24 is pressed, the self-service POS terminal 10 determines that operation by the store clerk is being performed. If a maintenance completion button among the operation buttons 24 is pressed, the self-service POS terminal 10 determines that the operation of the store clerk was completed.

The information monitor 25 is, for example, a liquid crystal monitor or an organic EL monitor and displays various kinds of information relating to an operation state and the like of the coin automatic change machine 20.

The key operation section 26 is an insertion port into which the store clerk inserts a dedicated key if operating the coin automatic change machine 20. If the key is inserted into the key operation section 26, the coin automatic change machine 20 enables, for example, the cover on the front surface to be opened and enables coins stored on the inside of the coin automatic change machine 20 to be taken out. That is, if the key was inserted into the key operation section 26 or if the inserted key rotated and moved to a specific position, the coin automatic change machine 20 determines that operation by the store clerk is being performed.

### (Schematic configuration of the bill automatic change machine)

A schematic configuration of the bill automatic change machine 30 is explained with reference to FIG. 4. FIG. 4 is an exterior view illustrating an example of the bill automatic change machine.

The bill automatic change machine 30 determines whether bills deposited by the customer for payment for a commodity are regular bills. The bill automatic change machine 30 integrates a deposit amount of regular bills and returns an excess of a payment amount as change. The bill automatic change machine 30 operates in cooperation with the coin automatic change machine 20 explained above and sets, as a deposit amount, a total amount of the coins deposited to the coin automatic change machine 20 and the bills deposited to the bill automatic change machine 30. If a non-regular bill is deposited, the bill automatic change machine 30 performs reject processing for returning the bill.

In order to perform these operations, the bill automatic change machine 30 includes a bill identification function of identifying a regular bill, a storing function of conveying deposited bills and storing the bills in different storing sections for each of denominations, a change return function of returning a difference value between a deposit amount and a payment amount as bills serving as change, and a reject function of returning non-regular bills. Since all of these functions are well known, detailed explanation of the functions is omitted.

Further, if the customer deposits bills and a total number of the deposited bills exceeds a predetermined value, the bill automatic change machine 30 in the present embodiment returns bills deposited in excess of the predetermined value. For example, if the store clerk supplies bills serving as change, collects deposited bills, and performs maintenance of the bill automatic change machine 30, even if bills exceeding the predetermined value in number are deposited, the bill automatic change machine 30 does not return the bills.

As illustrated in FIG. 4, the bill automatic change machine 30 includes, in the front and on the upper surface on the front side in a substantially rectangular parallelepiped housing, the bill depositing port 31, the bill return port 32, the foreign matter discharge port 33, operation buttons 34, an information monitor 35, and a key operation section 36. If the front cover 6 (see FIG. 2) is closed, the bill depositing port 31, the bill return port 32, and the foreign matter discharge port 33 are exposed to the surface of the self-service POS terminal 10 from a not-illustrated opening provided in the front cover 6. On the other hand, the operation buttons 34, the information monitor 35, and the key operation section 36 are hidden on the inside of the housing 1 if the front cover 6 is closed.

The operation buttons 34 are various buttons to be operated by the store clerk and give various instructions to the bill automatic change machine 30. For example, if a maintenance button among the operation buttons 34 is pressed, the self-service POS terminal 10 determines that operation by the store clerk is being performed. If a maintenance completion button among the operation buttons 34 is pressed, the self-service POS terminal 10 determines that the operation of the store clerk was completed.

The information monitor 35 is, for example, a liquid crystal monitor or an organic EL monitor and displays various kinds of information relating to an operation state and the like of the bill automatic change machine 30.

The key operation section 36 is an insertion port into which the store clerk inserts a dedicated key if operating the bill automatic change machine 30. If the key is inserted into the key operation section 36, for example, the bill automatic change machine 30 enables the cover on the front surface to be opened and enables the bills stored on the inside of the bill automatic change machine 30 to be taken out. That is, if the key was inserted into the key operation section 36 or if the inserted key moved to a specific position, the bill automatic change machine 30 determines that the operation by the store clerk is being performed.

### (Hardware configuration of the self-service POS terminal)

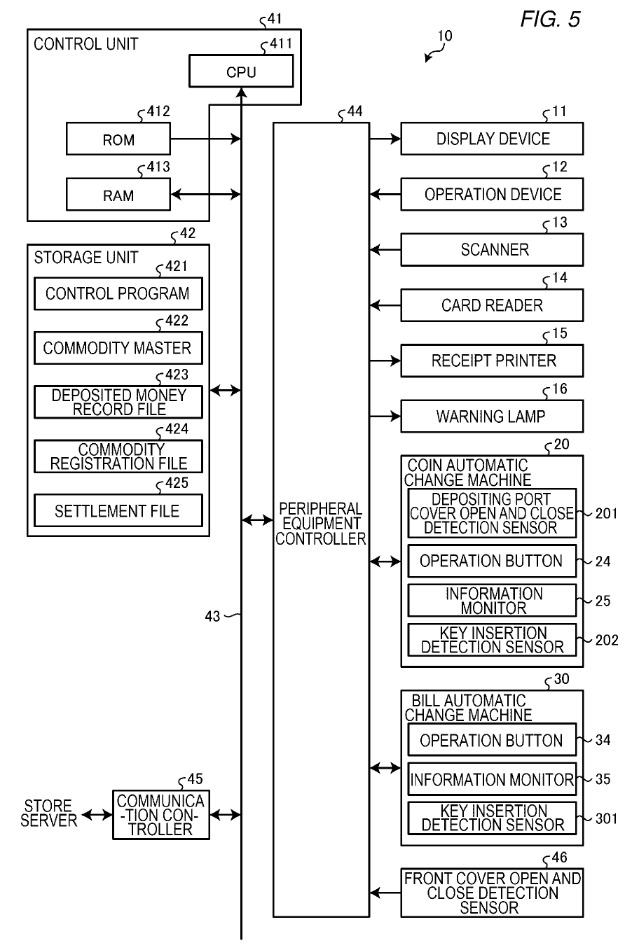

A hardware configuration of the self-service POS terminal 10 in the embodiment is explained with reference to FIG. 5. FIG. 5 is a hardware block diagram illustrating an example of a hardware configuration of the self-service POS terminal in the embodiment.

The self-service POS terminal 10 has a configuration in which a control unit 41, a storage unit 42, a peripheral equipment controller 44, and a communication controller 45 are connected to one another by an internal bus 43.

The control unit 41 controls an operation of the entire self-service POS terminal 10. The control unit 41 includes a CPU (Central Processing Unit) 411, a ROM (Read Only Memory) 412, and a RAM (Random Access Memory) 413. The CPU 411 is connected to the ROM 412 and the RAM 413 via an internal bus such as an address bus or a data bus. The CPU 411 loads, in the RAM 413, various programs stored in the ROM 412 and the storage unit 42. The CPU 411 operates according to the various programs loaded in the RAM 413 to control the operation of the self-service POS terminal 10. That is, the control unit 41 has a configuration of a general computer.

The storage unit 42 is a storage device such as a HDD (Hard Disk Drive) or an SSD (Solid State Drive). The storage unit 42 may be a nonvolatile memory such as a flash memory in which stored information is retained even if a power supply is turned off. The storage unit 42 stores a control program 421, a commodity master 422, a deposited money record file 423, a commodity registration file 424, and a settlement file 425.

The control program 421 is a program for controlling an operation of the entire self-service POS terminal 10. The control program 421 may be provided in a state of being stored in the storage unit 42 or may be provided by being recorded in a computer-readable non-transitory recording medium such as a CD-ROM, a flexible disk (FD), a CD-R, or a DVD as a file of an installable format or an executable format. The control program 421 may be stored on a computer connected to a network and provided by being downloaded through the network. Further, the control program 421 may be provided or distributed through a network such as the Internet.

The commodity master 422 is a master file storing commodity information such as commodity names and prices of sales target commodities. In the commodity master 422, a commodity name, a unit price, additional information, and the like are stored in correlation with a commodity code. Since content of a commodity master is updated at any time, the self-service POS terminal 10 acquires the latest commodity master from, for example, a not-illustrated store server via the communication controller 45 to thereby always update the content of the commodity master 422 to the latest state.

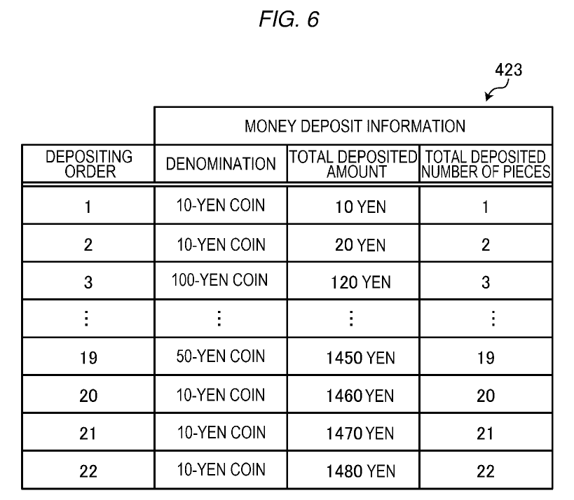

The deposited money record file 423 is a file storing denominations and depositing order of pieces of money deposited in one checkout. The deposited money record file 423 is explained in detail (see FIG. 6).

The commodity registration file 424 is a file storing registered commodity information (for example, a commodity name, the number of items, and a unit price) and a purchase total amount in correlation with a transaction code for specifying one transaction.

The settlement file 425 is a file storing settlement content (for example, a settlement date and time, a purchase total amount, a deposit amount, and a change amount) relating to the transaction in correlation with the transaction code.

The control unit 41 is connected to the display device 11, the operation device 12, the scanner 13, the card reader 14, the receipt printer 15, the warning lamp 16, the coin automatic change machine 20, the bill automatic change machine 30, and a front cover open and close detection sensor 46 via the peripheral equipment controller 44. Since overviews of the display device 11, the operation device 12, the scanner 13, the card reader 14, the receipt printer 15, and the warning lamp 16 are as explained above, redundant explanation thereof is omitted.

The coin automatic change machine 20 includes a depositing port cover open and close detection sensor 201, the operation buttons 24, the information monitor 25, and a key insertion detection sensor 202. Since the operation buttons 24 and the information monitor 25 are as explained above, redundant explanation thereof is omitted.

The depositing port cover open and close detection sensor 201 is a sensor that detects open and closed states of the depositing port cover 27. A configuration of the depositing port cover open and close detection sensor 201 is not limited and only has to be, for example, a configuration that can electrically or mechanically detect the open and closed states of the depositing port cover 27.

The key insertion detection sensor 202 is a sensor that detects that a key was inserted into the key operation section 26 or that the key inserted into the key operation section 26 rotated and moved to a specific position. A configuration of the key insertion detection sensor 202 is not limited and only has to be, for example, a configuration that can electrically or mechanically detect that the key was inserted into the key operation section 26 or that the key inserted into the key operation section 26 rotated and moved to the specific position.

The bill automatic change machine 30 includes the operation buttons 34, the information monitor 35, and a key insertion detection sensor 301. Since the operation button 34 and the information monitor 35 are as explained above, redundant explanation thereof is omitted.

The key insertion detection sensor 301 is a sensor that detects that a key was inserted into the key operation section 36 or that the key inserted into the key operation section 36 rotated and moved to a specific position. A configuration of the key insertion detection sensor 301 is not limited and only has to be, for example, a configuration that can electrically or mechanically detect that the key was inserted into the key operation section 36 or that the key inserted into the key operation section 36 rotated and moved to the specific position.

The front cover open and close detection sensor 46 is a sensor that can detect opened and closed states of the front covers 6 and 7. A configuration of the front cover open and close detection sensor 46 is not limited and only has to be, for example, a configuration that can electrically and mechanically detect the opened and closed states of the front coverts 6 and 7.

The control unit 41 performs communication with a not-illustrated store server via the communication controller 45. The self-service POS terminal 10 acquires the latest commodity master 422 from the store server. The self-service POS terminal 10 periodically outputs, to the store server, for example, the commodity registration file 424 and the settlement file 425 indicating a history of transactions.

### (Data structure of the deposited money record file)

A data structure of the deposited money record file 423 is explained with reference to FIG. 6. FIG. 6 is a diagram illustrating an example of a data structure of the deposited money record file.

The deposited money record file 423 stores, for each one checkout, denominations, the numbers, and deposit amounts of pieces of money deposited to the coin automatic change machine 20 and the bill automatic change machine 30. Timing when one checkout is started is set to, for example, timing when a not-illustrated checkout button displayed on the display device 11 was pressed, that is, timing when an instruction to start checkout was performed.

As illustrated in FIG. 6, the deposited money record file 423 stores denominations, a total deposit amount at that point in time, and a total number of deposited pieces of money at that point in time in association with the deposit order of the pieces of money.

As illustrated in FIG. 6, if a 10-yen coin is deposited first, a total deposit amount being 10 yen and the total number of deposited pieces being one are stored in the deposited money record file 423. Subsequently, if a 10-yen coin is deposited, the total deposit amount being 20 yen and the total number of deposited pieces being two are stored in the deposited money record file 423. Subsequently, if a 100-yen coin is deposited, the total deposit amount being 120 yen and the total number of deposited pieces being three are stored in the deposited money record file 423.

Thereafter, if the deposit of money continues and a 50-yen coin is deposited as a nineteenth coin, a 10-yen coin is deposited as a twentieth coin, a 10-yen coin is deposited as a twenty-first coin, and a 10-yen coin is deposited as a twenty-second coin, as illustrated in FIG. 6, the total deposit amount and the total number of deposited pieces are updated every time.

If the number of deposited pieces of the money exceeded a predetermined value (for example, twenty), the self-service POS terminal 10 in the embodiment returns the money deposited in excess of the predetermined value. Therefore, in the example illustrated in FIG. 6, the self-service POS terminal 10 returns the 10-yen coin deposited as the twenty-first coin and the 10-yen coin deposited as the twenty-second coin. It is desirable to return the money deposited as the twenty-first coin at a point in time when the deposit of the twenty-first coin is detected. If money is continuously deposited, the self-service POS terminal 10 updates stored content of the deposited money record file 423 after performing identification processing for identifying whether a deposited coin is a regular coin. Therefore, if the self-service POS terminal 10 detects that money exceeding twenty pieces is deposited, a slight time delay occurs. Therefore, as illustrated in FIG. 6, for example, at a point in time when the self-service POS terminal 10 detects that twenty-two pieces of money are deposited, the self-service POS terminal 10 detects that pieces of money exceeding twenty pieces are deposited. Then, the self-service POS terminal 10 returns two pieces of money (two 10-yen coins) deposited in excess of twenty pieces. The predetermined value, which is a threshold of the number of pieces that can be deposited of money can be set to any value. The set value is stored in, for example, the ROM 412 or the like.

FIG. 6 is an example in which information concerning deposited coins is stored. However, the deposited money record file 423 may store depositing order of coins and depositing order of bills in mixture. The deposited money record fille 423 may store depositing order of coins and depositing order of bills separately in different files. If the depositing order of coins and the depositing order of bills are separately stored in the different files, a total deposit amount obtained by totaling a deposit amount of coins and a deposit amount of bills is also managed.

The threshold (the predetermined value explained above) indicating the number of pieces of money to be returned may be set to different values for coins and bills or different predetermined values may be set for each of denominations. For example, larger predetermined values may be set for high denomination money such as a 500-yen coin, a 100-yen coin, a 10000-yen bill, and a 5000-yen bill compared with the other money. Accordingly, for example, if a deposit amount does not reach a purchase total amount at a point in time when twenty pieces of money set as a predetermined value are deposited, the customer can deposit money equal to or more than the purchase total amount by depositing high denomination money. In order to eliminate anxiety of the customer, the self-service POS terminal 10 desirably display, on the display device 11, an indication that, if money exceeding the predetermined value is deposited, the money is returned and information relating to a numerical value of the predetermined value.

### (Functional configuration of the self-service POS terminal)

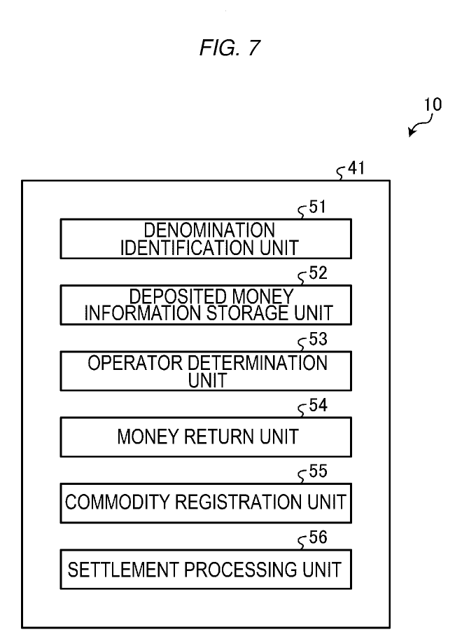

A functional configuration of the self-service POS terminal 10 in the embodiment is explained with reference to FIG. 7. FIG. 7 is a functional block diagram illustrating an example of a functional configuration of the self-service POS terminal in the embodiment.

The control unit 41 of the self-service POS terminal 10 loads the control program 421 in the RAM 413 and causes the control program 421 to operate to thereby implement, as functional units, a denomination identification unit 51, a deposited money information storage unit 52, an operator determination unit 53, a money return unit 54, a commodity registration unit 55, and a settlement processing unit 56 illustrated in FIG. 7. Some or all of the functional units may be implemented by dedicated hardware.

The denomination identification unit 51 determines whether money was deposited to the coin depositing port 21 (a depositing port) of the coin automatic change machine 20 and the bill depositing port 31 (a depositing port) of the bill automatic change machine 30 included in the self-service POS terminal 10 (the money depositing and dispensing apparatus). The denomination identification unit 51 identifies denominations of the money deposited to the depositing ports. The denomination identification unit 51 is an example of the identification unit in the present disclosure.

The deposited money information storage unit 52 stores, in the deposited money record file 423, denominations, the numbers, and depositing order of pieces of money deposited during one checkout. If a checkout instruction is performed or the self-service POS terminal 10 is operated by the store clerk, the deposited money information storage unit 52 initializes the deposited money record file 423. The deposited money information storage unit 52 is an example of the storage unit in the present disclosure.

The operator determination unit 53 determines whether the self-service POS terminal 10 (the money depositing and dispensing apparatus) is being operated by the customer or being operated by the store clerk. Specific determination is performed by any one of the following.

If the key insertion detection sensor 202 detected that a key was inserted into the key operation section 26 or detected that the key inserted into the key operation section 26 rotated and moved to a specific position, the operator determination unit 53 determines that the self-service POS terminal 10 is being operated by the store clerk. If the key insertion detection sensor 301 detected that a key was inserted into the key operation section 36 or detected that the key inserted into the key operation section 36 rotated and moved to a specific position, the operator determination unit 53 determines that the self-service POS terminal 10 is being operated by the store clerk. After determining that the self-service POS terminal 10 is being operated by the store clerk, if the key insertion detection sensor 202 detected that the key was removed from the key operation section 26 or the key insertion detection sensor 301 detected that the key was removed from the key operation section 36, the operator determination unit 53 determines that the operation of the store clerk ended.

On condition that the operation buttons 24 and 34 (for example, the maintenance button) for the store clerk to instruct to operate the self-service POS terminal 10 were operated, the operator determination unit 53 determines that the self-service POS terminal 10 is being operated by the store clerk. On condition that, after it was determined that the self-service POS terminal 10 is being operated by the store clerk, the operation buttons 24 and 34 (for example, the maintenance completion button) indicating that the store clerk completed the operation of the self-service POS terminal 10 were operated, the operator determination unit 53 determines that the operation of the store clerk ended. On condition that an operation button (for example, a maintenance button), which is displayed on the display device 11, for the store clerk to instruct to operate the self-service POS terminal 10 was operated, the operator determination unit 53 may determine that the self-service POS terminal 10 is being operated by the store clerk. On condition that, after it was determined that the self-service POS terminal 10 is being operated by the store clerk, an operation button (for example, a maintenance completion button), which is displayed on the display device 11, indicating that the store clerk ended the operation of the self-service POS terminal 10 was operated, the operator determination unit 53 may determine that the operation of the store clerk ended.

On condition that the depositing port cover open and close detection sensor 201 detected that the depositing port cover 27 is open, the operator determination unit 53 may determine that the self-service POS terminal 10 is being operated by the store clerk. On condition that, after it was determined that the self-service POS terminal 10 is being operated by the store clerk, the depositing port cover open and close detection sensor 201 detected that the depositing port cover 27 is closed, the operator determination unit 53 may determine that the operation of the store clerk ended.

On condition that the front cover open and close detection sensor 46 detected that at least one of the front covers 6 and 7 of the self-service POS terminal 10 is open, the operator determination unit 53 may determine that the self-service POS terminal 10 is being operated by the store clerk. On condition that, after it was determined that the self-service POS terminal 10 is being operated by the store clerk, the front cover open and close detection sensor 46 detected that both of the front covers 6 and 7 of the self-service POS terminal 10 were closed, the operator determination unit 53 may determine that the operation of the store clerk ended.

On condition that it was determined that the self-service POS terminal 10 is being operated by the customer, if money exceeding a predetermined value in number of pieces was deposited, the money return unit 54 returns money deposited in excess of the predetermined value. If non-regular money was deposited, the money return unit 54 returns the deposited non-regular money (non-regular coins or non-regular bills).

The commodity registration unit 55 performs commodity registration processing for storing, in the commodity registration file 424, a commodity code that the customer caused the scanner 13 to read. If a not-illustrated checkout button displayed on the display device 11 was pressed, the commodity registration unit 55 ends the commodity registration processing performed to that point and sets, as commodity registration information relating to one checkout, content registered in the commodity registration file 424 at that point in time.

If the not-illustrated checkout button displayed on the display device 11 was pressed, the settlement processing unit 56 determines that a checkout instruction was made from the customer. If a total amount of coins deposited to the coin automatic change machine 20 and bills deposited to the bill automatic change machine 30 is equal to or more than a purchase total amount of commodities registered in the commodity registration file 424, the settlement processing unit 56 performs cash settlement. The settlement processing unit 56 causes the receipt printer 15 to print a settlement result and dispenses the settlement result as a receipt. The settlement processing unit 56 is further included in the self-service POS terminal 10. The settlement processing unit 56 may cause a not-illustrated settlement terminal to perform cashless settlement such as credit settlement, code settlement, or electronic money settlement.

### (Flow of processing performed by the self-service POS terminal)

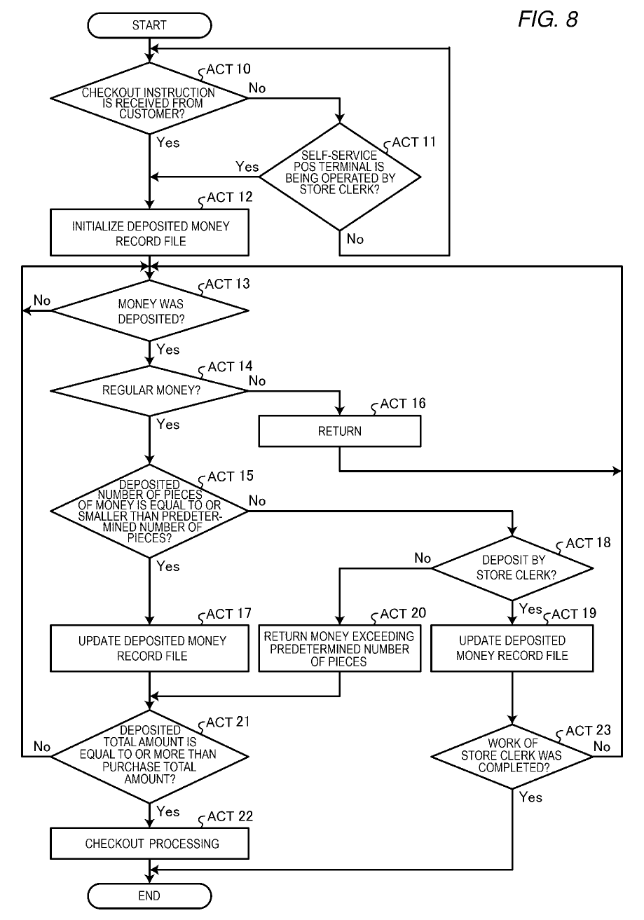

A flow of processing performed by the self-service POS terminal 10 in the embodiment is explained with reference to FIG. 8. FIG. 8 is a flowchart illustrating an example of a flow of processing performed by the self-service POS terminal in the embodiment.

The settlement processing unit 56 determines whether a checkout instruction is received from the customer (Act 10). If it is determined that the checkout instruction is received from the customer (Act 10: Yes), the processing proceeds to Act 12. On the other hand, if it is not determined that the checkout instruction is received from the customer (Act 10: No), the processing proceeds to Act 11.

If it is not determined in Act 10 that a checkout instruction is received from the customer, the operator determination unit 53 determines whether the self-service POS terminal 10 is being operated by the store clerk (Act 11). If it is determined that the self-service POS terminal 10 is being operated by the store clerk (Act 11: Yes), the processing proceeds to Act 12. On the other hand, if it is not determined that the self-service POS terminal 10 is being operated by the store clerk (Act 11: No), the processing returns to Act 10. For example, if a start of maintenance was instructed by the operation buttons 24 and 34, if a not-illustrated maintenance button displayed on the display device 11 was operated, if the depositing port cover open and close detection sensor 201 detected that the depositing port cover 27 is open, or if the front cover open and close detection sensor 46 detected that the front covers 6 and 7 of the self-service POS terminal 10 are open, the operator determination unit 53 determines that the self-service POS terminal 10 is being operated by the store clerk.

If it is determined in Act 10 that the checkout instruction is received from the customer or it is determined in Act 11 that the self-service POS terminal 10 is being operated by the store clerk, the deposited money information storage unit 52 initializes the deposited money record file 423 (Act 12).

The denomination identification unit 51 determines whether money was deposited (Act 13). If it is determined that money was deposited (Act 13: Yes), the processing proceeds to Act 14. On the other hand, if it is not determined that money was deposited (Act 13: No), the denomination identification unit 51 repeats the determination in Act 13.

If determining in Act 13 that money was deposited, the denomination identification unit 51 determines whether the deposited money is regular money (Act 14). If it is determined that the deposited money is regular money (Act 14: Yes), the processing proceeds to Act 15. On the other hand, if it is not determined that the deposited money is regular money (Act 14: No), the processing proceeds to Act 16.

If it is not determined in Act 14 that the deposited money is regular money, the money return unit 54 returns the deposited non-regular money (Act 16). Thereafter, the processing returns to Act 13.

If it is determined in Act 14 that the deposited money is regular money, the money return unit 54 determines whether the number of deposited pieces of money is equal to or smaller than a predetermined number of pieces (Act 15). If it is determined that the number of deposited pieces of money is equal to or smaller than the predetermined number of pieces (Act 15, Yes), the processing proceeds to Act 17. On the other hand, if it is not determined that the number of deposited pieces of money is equal to or smaller than the predetermined number of pieces (Act 15: No), the processing proceeds to Act 18.

If it is determined in Act 15 that the number of deposited pieces of money is equal to or smaller than the predetermined number of pieces, the deposited money information storage unit 52 stores denominations, the numbers, and depositing order of the deposited pieces of money in the deposited money record file 423 to thereby update the storage content of the deposited money record file 423.

On the other hand, if it is not determined in Act 15 that the number of deposited pieces of money is equal to or smaller than the predetermined number of pieces, the operator determination unit 53 determines whether the deposit is deposit by the store clerk (Act 18). If it is determined that the deposit is deposit by the store clerk (Act 18: Yes), the processing proceeds to Act 19. On the other hand, if it is not determined that the deposit is deposit by the store clerk (Act 18: No), the processing proceeds to Act 20. If it is determined in Act 11 that the self-service POS terminal 10 is being operated by the store clerk, the operator determination unit 53 determines that the deposit is deposit by the store clerk.

If it is determined in Act 18 that the deposit is deposit by the store clerk, the deposited money information storage unit 52 stores denominations, the numbers, and depositing order of the deposited pieces of money in the deposited money record file 423 to thereby update the storage content of the deposited money record file 423 (Act 19). Thereafter, the processing proceeds to Act 23.

The operator determination unit 53 determines whether the work of the store clerk was completed (Act 23). If it is determined that the work of the store clerk was completed (Act 23: Yes), the self-service POS terminal 10 ends the processing. On the other hand, if it is not determined that the work of the store clerk was completed (Act 23: No), the processing returns to Act 13. For example, if completion of the operation was instructed by the operation buttons 24 and 34, if a not-illustrated maintenance completion button displayed on the display device 11 was operated, if the depositing port cover open and close detection sensor 201 detected that the depositing port cover 27 is closed, or if the front cover open and close detection sensor 46 detected that the front covers 6 and 7 of the self-service POS terminal 10 are closed, the operator determination unit 53 determines that the work of the store clerk was completed.

On the other hand, if it is not determined in Act 18 that the deposit is deposit by the store clerk, the money return unit 54 refers to the storage content of the deposited money record file 423 to thereby return money deposited in excess of the predetermined number of pieces (Act 20). If the return of the money is completed, the processing proceeds to Act 21. Although not described in the flowchart, if the return of the money is completed, the deposited money information storage unit 52 updates the storage content of the deposited money record file 423.

Following Act 17 or Act 20, the settlement processing unit 56 determines whether a deposit total amount is equal to or more than a purchase total amount (Act 21). If it is determined that the deposit total amount is equal to or more than the purchase total amount (Act 21: Yes), the processing proceeds to Act 22. On the other hand, it is not determined that the deposit total amount is equal to or more than the purchase total amount (Act 21: No), the processing returns to Act 13.

If determining in Act 21 that the deposit total amount is equal to or more than the purchase total amount, the settlement processing unit 56 performs checkout processing for paying the purchase total amount of commodities from the deposit total amount (Act 22). Thereafter, the self-service POS terminal 10 ends the processing.

### (Action effects of the embodiment)

As explained above, the self-service POS terminal 10 (the money depositing and dispensing apparatus) in the embodiment is capable of performing at least cash settlement and includes the denomination identification unit 51 (the identification unit) that identifies a denomination of money deposited to the coin depositing port 21 (the depositing port) or the bill depositing port 31 (the depositing port), the deposited money information storage unit 52 (the storage unit) that stores denominations, the numbers, and depositing order of pieces of money deposited during one checkout, the operator determination unit 53 that determines whether the self-service POS terminal 10 is being operated by a customer or being operated by a store clerk, and the money return unit 54 that, on condition that it is determined that the self-service POS terminal 10 is being operated by the customer, if pieces of money exceeding a predetermined value in number were deposited, returns the money deposited in excess of the predetermined number. Therefore, if the customer operates the self-service POS terminal 10, it is possible to limit the number of pieces of money that can be deposited. Accordingly, it is possible to prevent a checkout time from being extended because the customer deposits a large amount of money. It is possible to reduce likelihood of money clogging in the coin automatic change machine 20 and the bill automatic change machine 30 because a large amount of money is deposited. It is possible to prevent the frequency and labor and time of money collection from increasing because the number of pieces of money deposited to the coin automatic change machine 20 and the bill automatic change machine 30 increases. Further, it is possible to prevent the frequency and labor and time for exchanging money in a bank from increasing because deposited money increases. Therefore, it is possible to reduce a fee for the exchange.

The self-service POS terminal 10 (the money depositing and dispensing apparatus) in the embodiment receives insertion of a key that the store clerk inserts in operating the self-service POS terminal 10. On condition that the key was inserted or that the inserted key moved to a specific position, the operator determination unit 53 determines that the self-service POS terminal 10 is being operated by the store clerk. Therefore, it is possible to easily and securely determine that the self-service POS terminal 10 is being operated by the store clerk.

The self-service POS terminal 10 (the money depositing and dispensing apparatus) in the embodiment includes the operation buttons 24 and 34 for the store clerk to instruct to operate the self-service POS terminal 10. On condition that the operation buttons 24 and 34 were operated, the operator determination unit 53 determines that the self-service POS terminal 10 is being operated by the store clerk. Therefore, it is possible to easily and securely determine that the self-service POS terminal 10 is being operated by the store clerk.

The self-service POS terminal 10 (the money depositing and dispensing apparatus) in the embodiment further includes the openable and closable depositing port cover 27 that limits the number of pieces of money that can be deposited at a time. On condition that the depositing port cover 27 was opened, the operator determination unit 53 determines that the self-service POS terminal 10 is being operated by the store clerk. Therefore, it is possible to easily and securely determine that the self-service POS terminal 10 is being operated by the store clerk.

The self-service POS terminal 10 (the money depositing and dispensing apparatus) in the embodiment is included in the housing 1 including the openable and closable front covers 6 and 7 (the cover). On condition that the front covers 6 and 7 were opened, the operator determination unit 53 determines that the self-service POS terminal 10 is being operated by the store clerk. Therefore, it is possible to easily and securely determine that the self-service POS terminal 10 is being operated by the store clerk.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A money depositing and dispensing apparatus configured to perform at least cash settlement, the money depositing and dispensing apparatus comprising:
an identification component configured to identify a denomination of money deposited to a depositing port included in the money depositing and dispensing apparatus;
a storage component configured to store denominations, numbers, and depositing order of pieces of money deposited during one checkout;
an operator determination component configured to determine whether the money depositing and dispensing apparatus is being operated by a customer or being operated by a store clerk; and
a money return component configured to, on condition that the money depositing and dispensing apparatus is being operated by the customer, if pieces of money exceeding a predetermined value in number are deposited, return the money deposited in excess of the predetermined value.

2. The money depositing and dispensing apparatus according to claim 1, wherein
the money depositing and dispensing apparatus receives insertion of a key that the store clerk inserts in operating the money depositing and dispensing apparatus, and
on condition that the key is inserted or that the inserted key moves to a specific position, the operator determination component determines that the money depositing and dispensing apparatus is being operated by the store clerk.

3. The money depositing and dispensing apparatus according to claim 1, wherein
the money depositing and dispensing apparatus includes an operation button for the store clerk to instruct to operate the money depositing and dispensing apparatus, and
on condition that the operation button is operated, the operator determination component determines that the money depositing and dispensing apparatus is being operated by the store clerk.

4. The money depositing and dispensing apparatus according to claim 1, wherein
the money depositing and dispensing apparatus further includes an openable and closable depositing port cover that limits a number of pieces of money that are deposited at once, and
on condition that the depositing port cover is opened, the operator determination component determines that the money depositing and dispensing apparatus is being operated by the store clerk.

5. The money depositing and dispensing apparatus according to claim 1, wherein
the money depositing and dispensing apparatus is included in a housing including an openable and closable cover, and
on condition that the cover is opened, the operator determination component determines that the money depositing and dispensing apparatus is being operated by the store clerk.

6. The money depositing and dispensing apparatus according to claim 1, further comprising:
a bill automatic change machine configured to determine whether bills deposited by the customer for payment for a commodity are regular bills, and to integrate a deposit amount of regular bills and returns an excess of a payment amount as change.

7. The money depositing and dispensing apparatus according to claim 1, further comprising:
a coin automatic change machine configured to determine whether coins deposited by the customer for payment for a commodity are regular coins, and to integrate a deposit amount of regular coins and returns an excess of a payment amount as change.

8. A method of controlling a money depositing and dispensing apparatus configured to perform at least cash settlement, the method comprising:
identifying a denomination of money deposited to a depositing port included in the money depositing and dispensing apparatus;
storing denominations, numbers, and depositing order of pieces of money deposited during one checkout;
determining whether the money depositing and dispensing apparatus is being operated by a customer or being operated by a store clerk; and
on condition that the money depositing and dispensing apparatus is being operated by the customer, if pieces of money exceeding a predetermined value in number are deposited, returning the money deposited in excess of the predetermined value.

9. The method according to claim 8, further comprising:
receives inserting a key into the money depositing and dispensing apparatus by the store clerk in operating the money depositing and dispensing apparatus, and
on condition that the key is inserted or that the inserted key moves to a specific position, determining that the money depositing and dispensing apparatus is being operated by the store clerk.

10. The method according to claim 8, wherein
the money depositing and dispensing apparatus includes an operation button for the store clerk to instruct to operate the money depositing and dispensing apparatus, and further comprising:
on condition that the operation button is operated, determining that the money depositing and dispensing apparatus is being operated by the store clerk.

11. The method according to claim 8, wherein
the money depositing and dispensing apparatus further includes an openable and closable depositing port cover that limits a number of pieces of money that are deposited at once, and further comprising:
on condition that the depositing port cover is opened, determining that the money depositing and dispensing apparatus is being operated by the store clerk.

12. The method according to claim 8, wherein
the money depositing and dispensing apparatus is included in a housing including an openable and closable cover, and further comprising:
on condition that the cover is opened, determining that the money depositing and dispensing apparatus is being operated by the store clerk.

13. The method according to claim 8, further comprising:
determining whether at least one of bills and coins deposited by the customer for payment for a commodity are regular bills and coins, and integrating a deposit amount of regular bills and coins and returning an excess of a payment amount as change.

14. A point of sales (POS) terminal configured to perform at least cash settlement, the POS terminal comprising:
an identification component configured to identify a denomination of money deposited to a depositing port included in the POS terminal;
a storage component configured to store denominations, numbers, and depositing order of pieces of money deposited during one checkout;
an operator determination component configured to determine whether the POS terminal is being operated by a customer or being operated by a store clerk; and
a money return component configured to, on condition that the POS terminal is being operated by the customer, if pieces of money exceeding a predetermined value in number are deposited, return the money deposited in excess of the predetermined value.

15. The POS terminal according to claim 14, wherein
the POS terminal receives insertion of a key that the store clerk inserts in operating the POS terminal, and
on condition that the key is inserted or that the inserted key moves to a specific position, the operator determination component determines that the POS terminal is being operated by the store clerk.

16. The POS terminal according to claim 14, wherein
the POS terminal includes an operation button for the store clerk to instruct to operate the POS terminal, and
on condition that the operation button is operated, the operator determination component determines that the POS terminal is being operated by the store clerk.

17. The POS terminal according to claim 14, wherein
the POS terminal further includes an openable and closable depositing port cover that limits a number of pieces of money that are deposited at once, and
on condition that the depositing port cover is opened, the operator determination component determines that the POS terminal is being operated by the store clerk.

18. The POS terminal according to claim 14, wherein
the POS terminal is included in a housing including an openable and closable cover, and
on condition that the cover is opened, the operator determination component determines that the POS terminal is being operated by the store clerk.

19. The POS terminal according to claim 14, further comprising:
a bill automatic change machine configured to determine whether bills deposited by the customer for payment for a commodity are regular bills, and to integrate a deposit amount of regular bills and returns an excess of a payment amount as change.

20. The POS terminal according to claim 14, further comprising:
a coin automatic change machine configured to determine whether coins deposited by the customer for payment for a commodity are regular coins, and to integrate a deposit amount of regular coins and returns an excess of a payment amount as change.
